(19) United States
(12) Patent Application Publication
(10) Pub. No.: US 2005/0037785 A1
(43) Pub. Date: Feb. 17, 2005

(54) METHOD OF HANDLING A RECEIVED TELEPHONE CALL

(76) Inventor: Liang-Fang Chen, Tai-Nan City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/604,769

(22) Filed: Aug. 14, 2003

(51) Int. Cl. H04Q 7/20

(52) U.S. Cl. 455/466

(57) ABSTRACT

A method of handling a telephone call received by a first telephone system. The method includes the first telephone system receiving a telephone call from a second telephone system, determining if the second telephone system is capable of receiving data messages in response to receiving the telephone call, and the first telephone system sending a data message to the second telephone system in response to determining that the second telephone system is capable of receiving data messages.

### BACKGROUND OF INVENTION

1. Field of the Invention

The present invention relates to a method for handling a received telephone call, and more specifically, to a method for handling a received telephone call based on characteristics of the caller.

2. Description of the Prior Art

With the increased flexibility that mobile phones offer comes a need for greater responsibility on the part of the users. Because mobile phones can be taken anywhere by a user, often times the user is in a situation in which it is not socially acceptable to answer a telephone call.

For instance, suppose that the mobile phone user is in a meeting and cannot be disturbed. To minimize the disruption to others, the user may disable all audible alerts of the mobile phone such as a standard ringing alert, signal reception alerts, message alerts, etc. Also, it is possible that a vibrating phone could also disturb others who are nearby, so the user may also turn off a vibration alert setting. For clarity, the mobile phone utilized by the user will be referred as a first telephone and a telephone utilized to call the first telephone will be referred to as a second telephone.

Unfortunately, when notification alerts of the first telephone are disabled, the user of the first telephone has no way of receiving a telephone call from the second telephone user. Conventionally, a voice answering service will handle the incoming telephone call by default and ask the second telephone user to leave a message for the user of the first telephone.

On the other hand, the user of the first telephone can change the default call handling setting from the voice answering system to a message notification. For example, a Short Messaging Service (SMS) message can be sent to the second telephone user to provide a message customized by the user of the first telephone. In this way, the user of the first telephone can send the second telephone user a message stating, “I am currently in a meeting”.

However, the second telephone may not be capable of receiving SMS messages, and therefore the user of the first telephone runs the risk of missing the call entirely. Suppose that the second telephone is part of a Public Switched Telephone Network (PSTN). Since PSTN telephones are not capable of receiving SMS messages, the second telephone will not receive the SMS message from the first telephone. Another problem occurs if the first telephone is not able to identify the telephone number of the second telephone. In order to send the SMS message to the second telephone, the first telephone needs to know what telephone number to send the message to. Moreover, since the default call handling setting of the first telephone was switched from the voice answering system to the message notification, the second telephone user will also not be able to leave a voice message for the user of the first telephone if the SMS message fails.

If the voice answering service is chosen as the default call handling setting for the first telephone, the second telephone will be able to leave a voice message for the first telephone regardless of whether the telephone number of the second telephone was identified, and regardless of whether the second telephone can receive SMS messages. However, if the user of the first telephone decides to change the call handling setting to sending SMS messages, the second telephone can only receive the SMS message if the first telephone can identify the telephone number of the first telephone and if the second telephone is capable of receiving SMS messages. Otherwise, the second telephone will not receive the SMS message, and the second telephone user will have no way of leaving a message for the user of the first telephone. Therefore, the user of the first telephone may be reluctant to change the default call handling setting to anything other than the voice answering service for the reasons explained above.

### SUMMARY OF INVENTION

It is therefore a primary objective of the claimed invention to provide a method of handling a telephone call received by a telephone system in order to solve the abovementioned problems.

According to the claimed invention, a method of handling a telephone call received by a first telephone system is disclosed. The method includes the first telephone system receiving a telephone call from a second telephone system, determining if the second telephone system is capable of receiving data messages in response to receiving the telephone call, and the first telephone system sending a data message to the second telephone system in response to determining that the second telephone system is capable of receiving data messages.

It is an advantage of the claimed invention that the first telephone system send a data message to the second telephone system after determining that the second telephone system is capable of receiving data messages. In this way, data messages will only be sent to telephones that are capable of receiving the data messages.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a first telephone communicating with a second telephone through a base station.

FIG. 2 is a detailed diagram of the first telephone shown in FIG. 1.

FIG. 3 is a diagram showing menus used to select a default auto-answer mode according to the present invention.

FIG. 4 is a diagram showing menus used to select a customized auto-answer mode according to the present invention.

FIG. 5 is a state diagram showing the first telephone switching between auto-answer mode and normal mode.

FIG. 6 is a flowchart illustrating call handling according to the present invention.

### DETAILED DESCRIPTION

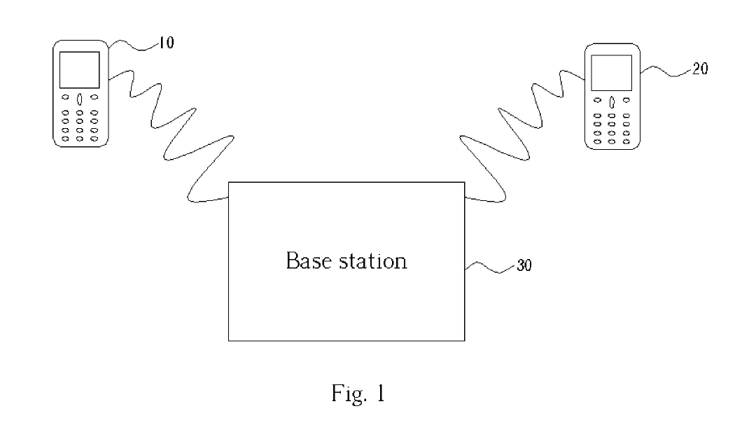

Please refer to FIG. 1. FIG. 1 is a diagram of a first telephone 10 communicating with a second telephone 20 through a base station 30. For the following disclosure, the present invention will be described from the point of view of the first telephone 10 receiving a telephone call from the second telephone 20. The first telephone 10 and the base station 30 belong to a first telephone system. The second telephone 20 may belong to the same telephone system as the first telephone 10 or to a different telephone system.

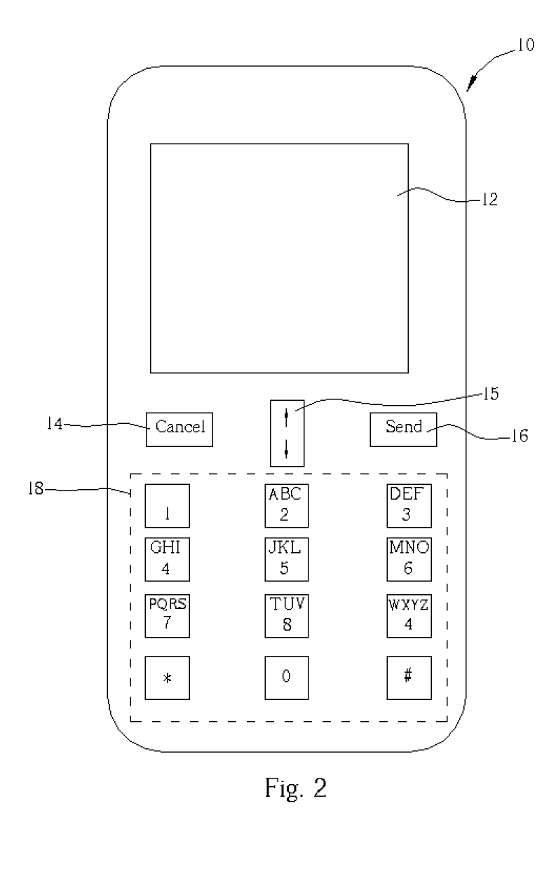

Please refer to FIG. 2. FIG. 2 is a detailed diagram of the first telephone 10 shown in FIG. 1. The first telephone 10 includes a display 12 such as a liquid crystal display (LCD), a cancel key 14, a send key 16, a directional key 15, and a plurality of numeric keys 18 containing the twelve standard keys 0-9, “#”, and “*”.

When the user of the first telephone 10 is in a situation in which he would not like to be disturbed by the first telephone 10, the user can switch the mode of the first telephone 10 to an auto-answer mode. In auto-answer mode, audible, visual, and vibration alert settings of the first telephone 10 can be disabled. The user of the first telephone 10 can conveniently switch the first telephone 10 between normal mode and auto-answer mode by pressing keys on the first telephone 10.

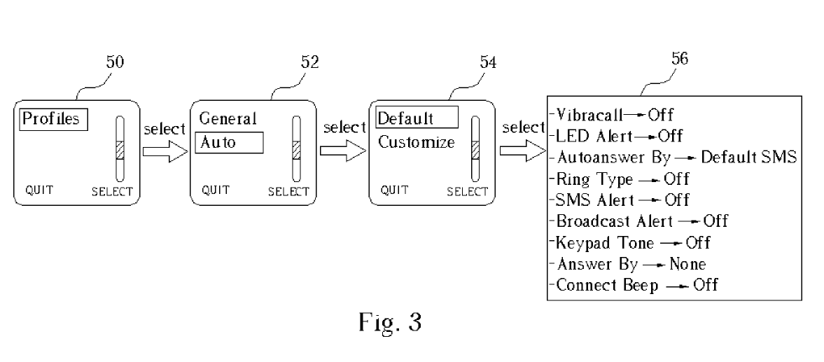

Please refer to FIG. 3. FIG. 3 is a diagram showing menus used to select a default auto-answer mode according to the present invention. In all of the following menus, pressing the cancel key 14 will quit the current menu, whereas pressing the send key 16 will select the boxed choice. Each menu shown in FIG. 3 is a result of pressing the send key 16 to select the boxed choice in the previous menu.

Menu 50 is used for selecting a profile of the first telephone 10. Menu 52 is used for selecting a general profile or the auto-answer mode profile. Menu 54 is used to choose between a default version and a customized version of the auto-answer mode. Finally, menu 56 shows all the alert settings controlled by the default version of the auto-answer mode. As an example, the default version of the auto-answer mode can disable the vibration alert setting, disable any LED alerts on the first telephone 10, use an SMS message as a default handling process for answering received telephone calls (as will be explained later), disable all audible rings for received telephone calls, disabling notification of received SMS messages, disabling broadcast signal notifications, disabling keypad tones, prevent all keys on the first telephone 10 from being used to answer a received telephone call, and disabling audible alerts when a telephone connection is made.

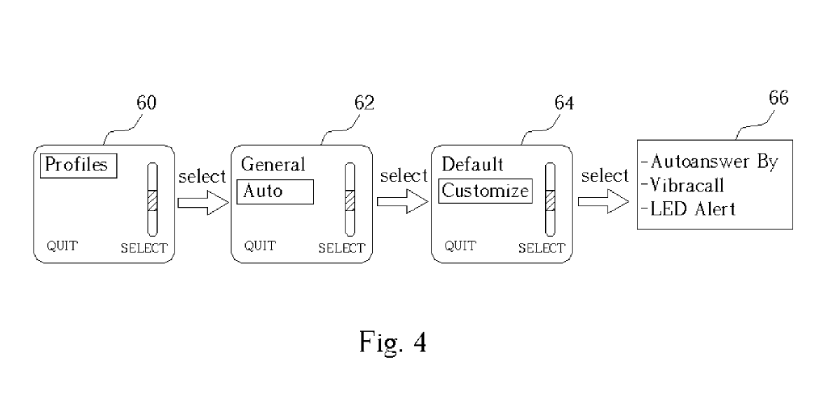

Please refer to FIG. 4. FIG. 4 is a diagram showing menus used to select a customized auto-answer mode according to the present invention. As in FIG. 3, in all of the following menus, pressing the cancel key 14 will quit the current menu, whereas pressing the send key 16 will select the boxed choice. Each menu shown in FIG. 4 is a result of pressing the send key 16 to select the boxed choice in the previous menu.

Menu 60 is used for selecting the profile of the first telephone 10. Menu 62 is used for selecting a general profile or the auto-answer mode profile. Menu 64 is used to choose between the default version and the customized version of the auto-answer mode. Finally, menu 66 shows example alert settings that can be controlled by the customized version of the auto-answer mode. As an example, three settings are available for customization in the customized version of the auto-answer mode. The user of the first telephone 10 can specify a default handling process for answering received telephone calls such as an SMS message, a voice answering system, etc. The user can also enable or disable the vibration alert setting and the LED alert setting.

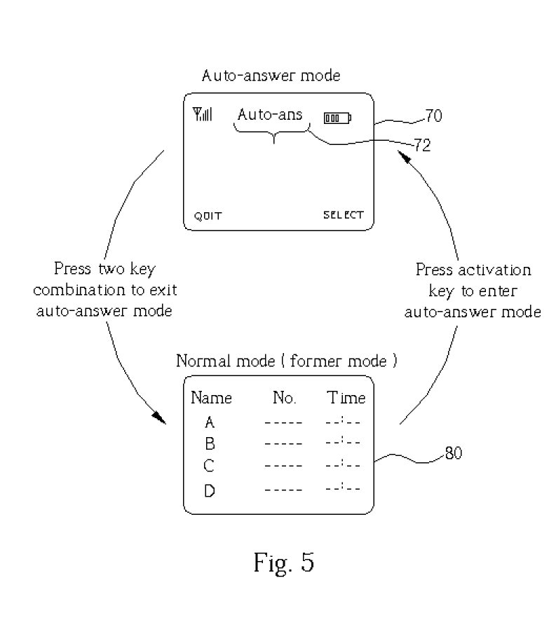

Please refer to FIG. 5. FIG. 5 is a state diagram showing the first telephone 10 switching between auto-answer mode and normal mode. Pressing keys on the first telephone 10 enables the user of the first telephone 10 to quickly switch between auto-answer mode and normal mode. State 70 shows the first telephone 10 in the auto-answer mode, and an indicator 72 is shown on the display 12 of the first telephone 10 for conveniently indicating that the first telephone 10 is in the auto-answer mode. While in the auto-answer mode, to prevent the first telephone 10 from being accidentally switched to normal mode, a two-key combination is preferably used to transfer the first telephone 10 from the auto-answer mode to the normal mode. For instance, suppose that the send key 16 is to be pressed in conjunction with a selected numeric key 18 for switching the first telephone 10 to the normal mode. State 80 shows the first telephone 10 in the normal mode, which can also be thought of as the former mode. The normal mode can display any menu that the first telephone 10 was in before switching to the auto-answer mode. For example, state 80 shows a listing of recent calls received. In order to switch from the normal mode (state 80) back to the auto-answer mode (state 70), a predetermined activation key is pressed while in normal mode. Thus, by pressing keys on the first telephone 10, the user of the first telephone 10 can quickly switch between the normal mode and the auto-answer mode.

One of the biggest advantages of the present invention is the ability of the first telephone 10 to handle received telephone calls in a variety of ways. The user of the first telephone 10 puts the first telephone 10 in auto-answer mode because he is busy or does not wish to be disturbed at that moment. Therefore, the present invention allows the user of the first telephone 10 to select various call handling settings for handling received telephone calls. For example, suppose that the user would prefer to send an SMS text message to the second telephone 20 user who calls the first telephone 10 while the first telephone 10 is in auto-answer mode. In order for the first telephone 10 to successfully send an SMS message to the second telephone 20, two criteria must first be met. To start with, the first telephone 10 has to be able to identify the telephone number of the second telephone 20 in order to send the SMS message to the second telephone 20. Next, the second telephone 20 has to be a telephone capable of receiving SMS messages, such as a mobile telephone that is part of a compatible mobile telephone network. If at least one of these criteria is not met, then the first telephone 10 is unable to send the SMS message to the second telephone 20. In this case, the present invention provides a method for handling the received telephone call with a second process, such as the voice answering service. Therefore, no received telephone calls from the second telephone 20 will be missed because the second telephone 20 does not meet necessary criteria.

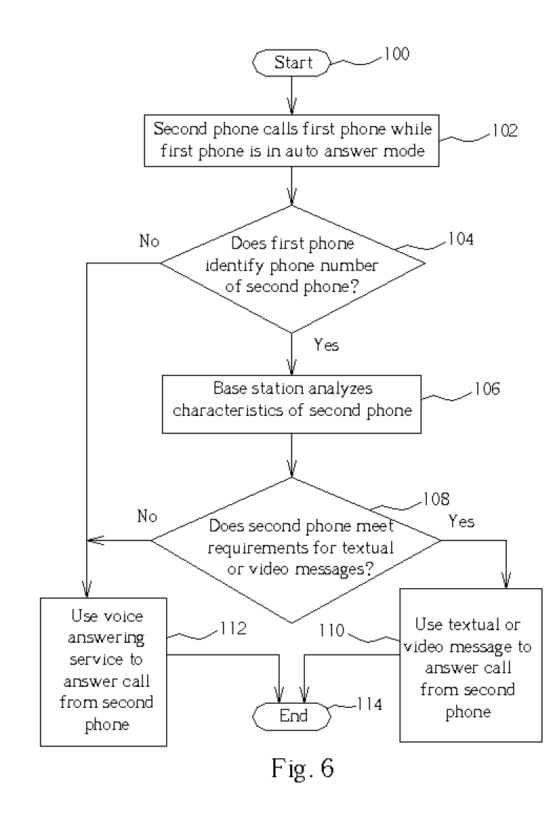

Please refer to FIG. 6. FIG. 6 is a flowchart illustrating call handling according to the present invention. Steps contained in the flowchart will be explained below.

Step 100: Start;

Step 102: The second telephone 20 calls the first telephone 10 while the first telephone 10 is in the auto-answer mode;

Step 104: Determine if the first telephone 10 is able to identify the telephone number of the second telephone 20; if so, go to step 106; if not, go to step 112;

Step 106: The base station 30 analyzes the characteristics of the second telephone 20;

Step 108: The base station 30 determines if the second telephone 20 is able to receive textual or video messages; if so, go to step 110; if not, go to step 112;
Step 110: According to the preferences of the user of the first telephone 10, the first telephone 10 handles the received call from the second telephone 20 by sending a textual message or a video message to the second telephone 20; go to step 114;

Step 112: Since the first telephone 10 is not able to send a textual or video message to the second telephone 20, the voice answering service is used to handle the call received from the second telephone 20; and

Step 114: End.

In summary, the present invention provides a method for handling a received telephone call with a specified handling process. The user of the first telephone 10 is able to customize preferences of the auto-answer mode, such that the first telephone 10 can handle received telephone calls with a textual or video message (such as an SMS message), or with a voice answering service. Please note that the present invention method is not limited to mobile phone systems, and can also be used in any telephone system that is capable of automatically handling a received telephone call with more than one call handling process.

Compared to the prior art method of handling a received telephone call, the present invention method can prevent calls from being missed regardless of the characteristics of the caller's telephone. In the prior art method, calls could be missed if the user of the first telephone specified handling received telephone calls by sending out a textual or video message and the second telephone could not receive messages. The present invention offers greater flexibility. If the second telephone is not able to receive textual or video messages, a voice answering service will automatically handle the received call. As a result, no received calls will be missed, and the user of the first telephone still has the option to send messages as a primary means of handling received calls.

Those skilled in the art will readily observe that numerous modifications and alterations of the device may be made while retaining the teachings of the invention. Accordingly, the above disclosure should be construed as limited only by the metes and bounds of the appended claims.

1. A method of handling a telephone call received by a first telephone system, the method comprising:
the first telephone system receiving a telephone call from a second telephone system;
determining if the second telephone system is capable of receiving data messages in response to receiving the telephone call; and
the first telephone system sending a data message to the second telephone system in response to determining that the second telephone system is capable of receiving data messages.

2. The method of claim 1 wherein determining if the second telephone system is capable of receiving data messages comprises the first telephone system successfully identifying a telephone number of the second telephone system.

3. The method of claim 1 further comprising the first telephone system completing the telephone call with the second telephone system to accept voice data for a mailbox of the first telephone system in response to determining that the second telephone system is not capable of receiving data messages.

4. The method of claim 1 wherein the data message is a textual message.

5. The method of claim 1 wherein the data message is a video message.

6. The method of claim 1 wherein the data message is a Short Messaging Service (SMS) message.

7. The method of claim 1 wherein the data message is an Enhanced Messaging Service (EMS) message.

8. The method of claim 1 wherein the data message is a Multimedia Messaging Service (MMS)

9. The method of claim 1 wherein the first telephone system comprises a mobile telephone and a base station, and the base station determines if the second telephone system is capable of receiving data messages.

10. The method of claim 9 further comprising the base station connecting the telephone call with a voice mailbox of the mobile telephone in response to determining that the second telephone system is not capable of receiving data messages.

11. The method of claim 1 wherein determining if the second telephone system is capable of receiving data messages comprises determining if a user device originating the telephone call in the second telephone system is capable of accepting data messages.
